(19) United States
(12) Patent Application Publication
(10) Pub. No.: US 2016/0057239 A1
(43) Pub. Date: Feb. 25, 2016

(54) MANAGING CODESET CONVERTER USAGE OVER A COMMUNICATIONS NETWORK

(71) Applicant: International Business Machines Corporation, Armonk, NY (US)

(72) Inventors: David N. Clissold, Austin, TX (US); Su Liu, Austin, TX (US); Priya Paul, Austin, TX (US); Shunguo Yan, Austin, TX (US)

(21) Appl. No.: 14/463,797

(22) Filed: Aug. 20, 2014

(51) Int. Cl. H04L 29/08; G06F 17/30; H04L 12/26

(52) U.S. Cl. CPC H04L 67/22; H04L 43/0876; G06F 17/30864

(57) ABSTRACT

A method for managing codeset converter usage between various computational devices associated with a plurality of users in communication over a network is provided. The method may include receiving, by a computer over the network, a user-defined codeset converter from a user associated with the plurality of users. A category for the user is then determined from among a plurality of predetermined categories. One or more other users associated with the plurality of users are determined, whereby the one or more other users include a substantially identical category to that of the determined category of the user. The received user-defined codeset converter is then distributed to the one or more other users having the substantially identical category via the network, whereby the distributed user-defined codeset converter provides a customized codeset mapping table for the user and the one or more other users based on the determined category.

### BACKGROUND

The present invention generally relates to computer communications, and more particularly, to managing codeset converter usage between various computational devices in communication over one or more networks.

A codepage or codeset may refer to a table of values that describe a character set for encoding a particular language. For example, according to the Unicode/UTF-8 codeset standard, the registered trademark symbol ‘®’ is represented by Unicode code value U+00AE. However, within the GB 18030 codeset standard, the symbol ‘®’ is represented by GB18030 code value 0x81308533. Accordingly, a codeset converter would convert the code value (e.g., U+00AE) for a character (e.g., ®) in one codeset standard (e.g., Unicode) to another code value (e.g., 0x81308533) for the same character (e.g., ®) in another codeset standard (e.g., GB18030) using, for example, a codeset mapping table.

Generally, codesets may be standardized, whereby codeset converters across different operating system (OS) platforms use the same codeset standards (e.g., ISO8859-1, Unicode, GB18030, IBM-943). Many codeset standards contain a Private Use Area (PUA) to allow vendors and users to define their own characters. However, the generation of user defined characters (UDCs) within a particular codeset converter may contribute to the creation of a non-standardized codeset converter that is utilized by the operating systems running on different computer platforms. For example, a standardized codeset converter running on a first computer platform may be customized to include a first UDC. Further, the same standardized codeset converter running on a second computer platform may be customized to include a second UDC that is different than the first UDC. Accordingly, across the first and the second computer platform, the standardized codeset converter usage becomes heterogeneous, whereby each computer platform is unable to process the other computer's UDC.

### BRIEF SUMMARY

According to one exemplary embodiment, one or more customized codeset converters associated with one or more computer users may be distributed over a communications network to one or more other computer users in order to facilitate the use of homogeneous codeset standards. The customized codeset converters may be distributed on the basis of different user-based criteria, such as, but not limited to, language, geographical location, and/or business activity.

According to another exemplary embodiment, a method for managing customized codeset converters among a plurality of one or more users in communication over a network is provided. The method may include receiving, by a computer over the network, a user-defined codeset converter from a user associated with the plurality of users. A category may be determined for the user from among one or more predetermined categories. One or more other users associated with the plurality of users may be determined, whereby the one or more other users include a substantially identical category to that of the determined category of the user. The received user-defined codeset converter may then be distributed to the one or more other users having the substantially identical category via the network, whereby the distributed user-defined codeset converter provides a customized codeset mapping table for the user and the one or more other users based on the determined category.

According to another exemplary embodiment, a computer program product for managing customized codeset converters among a plurality of one or more users in communication over a network is provided. The computer program product may include a computer-readable storage device and program instructions stored on one or more tangible storage devices. The program instructions are executable by a processor for performing a method that may accordingly include receiving, over the network, a user-defined codeset converter from a user associated with the plurality of users. A category may be determined for the user from among one or more predetermined categories. One or more other users associated with the plurality of users may be determined, whereby the one or more other users include a substantially identical category to that of the determined category of the user. The received user-defined codeset converter may then be distributed to the one or more other users having the substantially identical category via the network, whereby the distributed user-defined codeset converter provides a customized codeset mapping table for the user and the one or more other users based on the determined category.

According to another exemplary embodiment, a computer system for managing customized codeset converters among a plurality of one or more users in communication over a network is provided. The computer system may include one or more processors, one or more computer-readable memories, one or more computer-readable tangible storage devices, and program instructions stored on at least one of the one or more storage devices for execution by at least one of the one or more processors via at least one of the one or more memories. The computer system is capable of performing a method that may accordingly include receiving, over the network, a user-defined codeset converter from a user associated with the plurality of users. A category may be determined for the user from among one or more predetermined categories. One or more other users associated with the plurality of users may be determined, whereby the one or more other users include a substantially identical category to that of the determined category of the user. The received user-defined codeset converter may then be distributed to the one or more other users having the substantially identical category via the network, whereby the distributed user-defined codeset converter provides a customized codeset mapping table for the user and the one or more other users based on the determined category.

### BRIEF DESCRIPTION OF THE SEVERAL VIEWS OF THE DRAWINGS

FIG. 1A is a table corresponding to an exemplary codeset converter.

FIG. 1B is a table corresponding to an exemplary user-defined codeset converter.

FIG. 2 is a system block diagram of a Codeset Converter Management (CCM) system according to one exemplary embodiment.

FIG. 3 is an operational flow chart corresponding to a CCM program according to an exemplary embodiment.

FIG. 4 is an operational flow chart corresponding to a category determining process utilized by a CCM program according to an exemplary embodiment.

FIG. 5 is an operational flow chart corresponding to a distribution process utilized by a CCM program according to an exemplary embodiment.

FIG. 6 is a block diagram of hardware and software for executing the process flows of FIGS. 3-5 according to one embodiment.

The drawings are not necessarily to scale. The drawings are merely schematic representations, not intended to portray specific parameters of the invention. The drawings are intended to depict only typical embodiments of the invention. In the drawings, like numbering represents like elements.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. Rather, these exemplary embodiments are provided so that this disclosure will be thorough and complete and will fully convey the scope of this invention to those skilled in the art. In the description, details of well-known features and techniques may be omitted to avoid unnecessarily obscuring the presented embodiments.

The one or more exemplary embodiments described herein manage customized codeset converters associated with one or more computer users/entities on a communications network (e.g., cloud computing environment). The customized codeset converters may be distributed over the communications network to one or more other computer users/entities in order to facilitate the use of homogeneous codeset standards. The customized codeset converters may be distributed on the basis of different user-based criteria, such as, but not limited to, language (e.g., English, Japanese, Chinese, etc.), geographical location (e.g., North America, Asia, etc.), and/or business activity (e.g., Banking, Education, Law, Airlines, etc.).

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

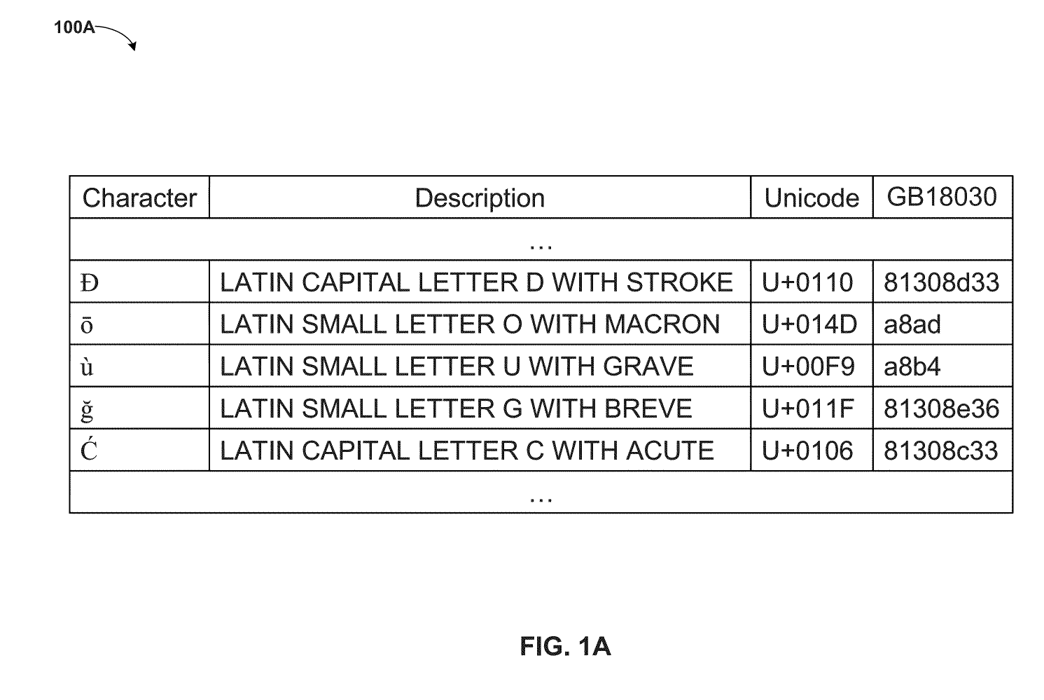

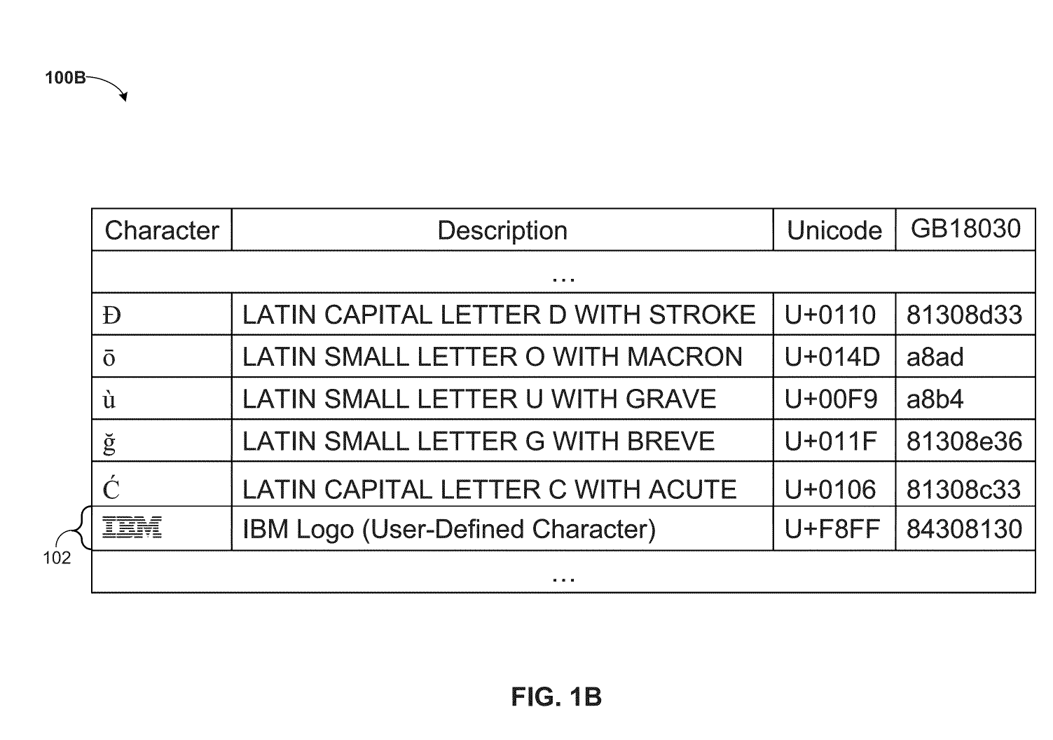

Referring to FIG. 1A, a table corresponding to an exemplary codeset converter 100A is depicted. Codeset converter 100A may contain one or more code values for two or more codeset standards (e.g., ISO8859-1, ISO8859-6, Unicode/UTF-8, GB18030, IBM-943, etc.) that correspond to a common character. For example, a first code value ‘U+0110’ and a second code value ‘0x81308d33’ correspond to a Latin capital letter D with a stroke ‘D’ in Unicode and GB 18030, respectively.

Referring to FIG. 1B, a table corresponding to an exemplary user-defined codeset converter 100B is depicted. User-defined codeset converter 100B may contain a user-defined character 102. User defined character 102 may be, among other things, a corporate logo, such as, for example, an IBM logo ‘ [symbol] ’. The user-defined character 102 may have a pair of code values for two respective codeset standards (i.e., Unicode and GB 18030) that falls within the respective codeset standards' Private Use Areas (e.g. U+E000 to U+F8FF for Unicode). Accordingly, a user may generate one or more user-defined characters for use within their computer infrastructure. For example, User A, may use a first operating system that utilizes the Unicode codeset standard and define the user-defined character 102 as customized code value U+F8FF. Furthermore, User B, may use a second operating system that utilizes the GB 18030 codeset standard but does not have a character assigned to the user-defined code value 84308130. Accordingly, if User A using Unicode were to send user-defined character 102 (e.g., contained in a file) to User B using GB 18030, user-defined character 102 may not properly be displayed. For example, user-defined character 102 may be displayed as, among other things, an error character [symbol] to User B based on User B not being able to convert user-defined character 102 from User A's Unicode standard to one recognizable by User B's GB18030 standard. Thus, user-defined codeset converter 100B may be necessary to correctly map the Unicode code value utilized by User A to the GB 18030 code value utilized by User B in order to properly display the user-defined character 102 on both systems.

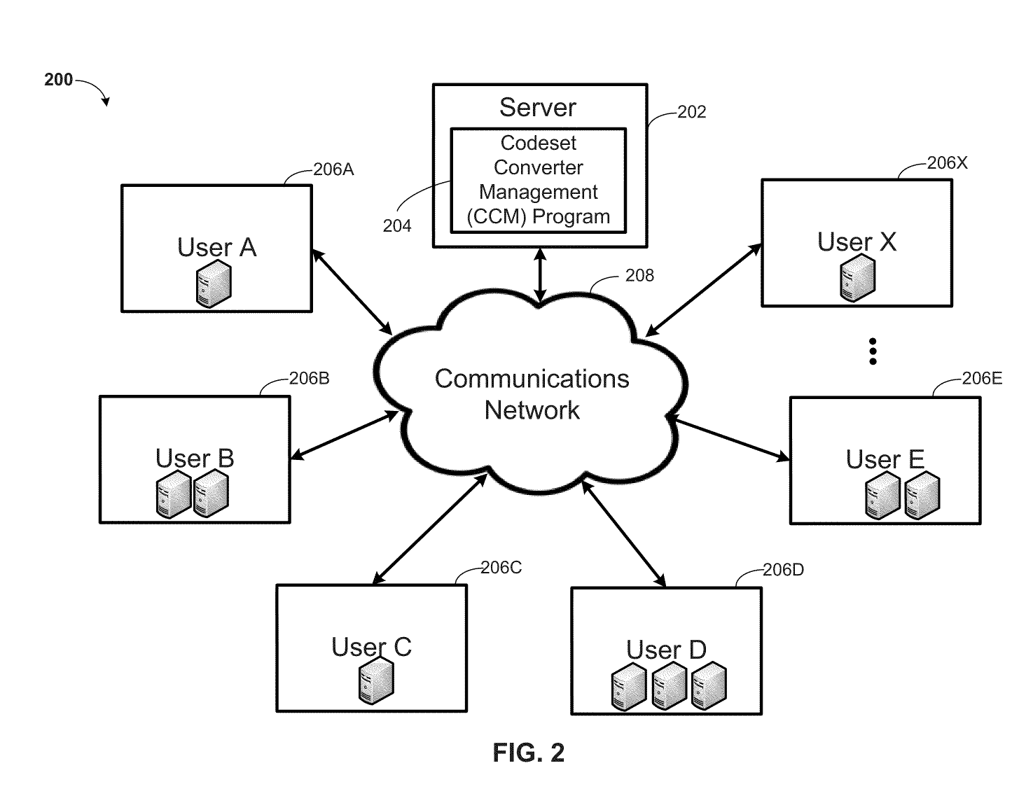

FIG. 2 depicts a system block diagram of a Codeset Converter Management system 200 according to one exemplary embodiment. The Codeset Converter Management system 200 may include a server 202, a Codeset Converter Management (CCM) program 204 located on server 202, and a plurality of one or more users 206A-206X connected over a communications network 208. Communications network 208 may be, among other things, a cloud computing environment, such as the Internet, whereby CCM program 204 may accordingly be implemented using a “Software as a Service” (SaaS) model. In operation, user 206A, for example, may create a user-defined codeset converter 100B (FIG. 1B) containing a user-defined character 102 (i.e., FIG. 1B: ‘ [symbol] ’). User 206A may accordingly upload the user-defined codeset converter 100B to server 202 via communications network 208. CCM program 204 may then distribute, over communications network 208, the user-defined codeset converter 100B to one or more other users, such as user 206B, from among the plurality of users 206A-206X. The distribution of the user-defined codeset converter 100B to one or more of the plurality of users 206A-206X may be based on one or more predetermined user parameters/criteria associated with the users 206A-206X. Using such parameters, the CCM program 204 may distribute the user-defined codeset converter 100B to one or more users from among the plurality of users 206A-206X that may utilize the user-defined character 102.

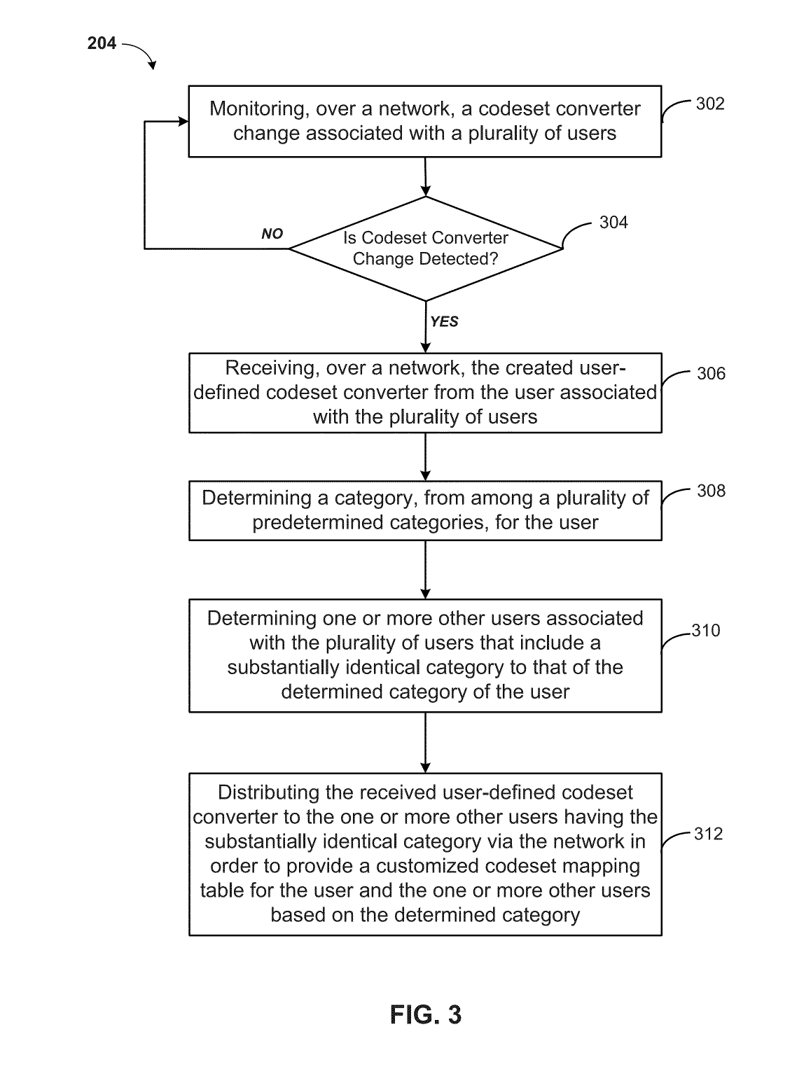

FIG. 3 is an operational flow chart corresponding to CCM program 204 (FIG. 2) associated with the exemplary embodiment depicted in FIG. 2. The CCM program 204 of FIG. 3 may be described with the aid of the exemplary embodiments of FIG. 1A, FIG. 1B, and FIG. 2.

At 302, a codeset converter change associated with a plurality of users is monitored. For example, CCM program 204 may monitor a plurality of users 206A-206X (FIG. 2) over communications network 208 (FIG. 2) in order to determine, among other things, a codeset converter change associated with any one or more of the plurality of users 206A-206X. A codeset converter change may be considered to be, among other things, the creation of a user-defined codeset converter 100B (FIG. 1B) by the addition of a user-defined character 102 (FIG. 1B) to an existing codeset converter 100A (FIG. 1A). CCM program 204 may perform the monitoring of the plurality of users 206A-206X by polling communications network 208 to detect a codeset converter change. For example, in some implementations, the CCM program 204 may reside within the operating system (OS). Further, a daemon associated with the OS of one or more user from among the plurality of users 206A-206X may be used by the CCM program 204 to monitor codeset converter changes over the communications network 208.

At 304, a codeset converter change is detected based on a created user-defined codeset converter by a user associated with the plurality of users. In operation, CCM program 204 may poll communications network 208 (FIG. 2) in order to determine if a change has been made to codeset converter 100A (FIG. 1A). User 206A (FIG. 2), for example, may add user-defined character 102 (FIG. 1B) to codeset converter 100A to create user-defined codeset converter 100B (FIG. 1B). Upon the creation of user-defined codeset converter 100B, CCM program 204 may detect that a codeset converter change has taken place and a customized codeset converter created. If, however, a change is not detected, CCM program 204 may continue to monitor communications network 208 for a codeset converter change.

At 306, if a change to an existing codeset converter is detected, the created user-defined codeset converter from the user associated with the plurality of users is received by over the network. For example, upon detecting a codeset converter change, CCM program 204 may receive user-defined codeset converter 100B (FIG. 1B) from user 206A (FIG. 2). CCM program 204 may then store user-defined codeset converter 100B on server 202 (FIG. 2). It may be appreciated that user-defined codeset converter 100B may be stored on server 202 on any form of computer readable storage media at the location of the server 202 locally and/or remotely.

At 308, a category is determined for the user from among a plurality of predetermined categories. For example, CCM Program 204 may collect data associated with user 206A (FIG. 2). This data may include, among other things, data corresponding to existing codeset converters, data corresponding to locale, data corresponding to geolocation, and data corresponding to computer platform. CCM Program 204 may then use the collected data to assign a category to user 206A from among one or more predetermined categories. These categories may accordingly include a locale category corresponding to language usage associated with a user, a geolocation category corresponding to geographical location associated with a user, and a business category corresponding to an industry or business model associated with a user. It may be appreciated that a myriad of other data collection sources and categories may be utilized. This data may accordingly include one or more of, among other things, operating system names, releases, and versions; language and culture settings; running codeset converters; a list of installed codeset converters; codeset versions; codeset converter patches; codeset mapping files; codeset converter usage; running and installed applications; user profiles and related information; geo-location; default languages; application profiles; platforms of connected clients and servers; and major encodings of inbound and outbound data.

At 310, one or more other users associated with the plurality of users are determined, whereby the one or more other users include a substantially identical category to that of the determined category of the user. In operation, CCM program 204 may identify user 206B (FIG. 2), for example, as belonging to a substantially similar category to that of user 206A (FIG. 2). It may be appreciated that the categorization process for determining the one or more other users is substantially identical to the categorization process as described for 308 above.

At 312, the received user-defined codeset converter is distributed to the one or more other users having the substantially identical category. This distribution takes place over the network in order to provide a customized codeset mapping table for the user and the one or more other users sharing the same determined category. For example, CCM program 204 may distribute user-defined codeset converter 100B (FIG. 1B) by making user-defined codeset converter 100B available for download, over communications network 208 (FIG. 2), to the plurality of users 206A-206X (FIG. 2). Alternatively, CCM program 204 may make user-defined codeset converter 100B available only to the one or more other users (i.e., user 206B) having the determined substantially identical category to user 206A. The one or more other users may then implement user-defined codeset converter 100B to decode user-defined character 102 (FIG. 1B), created by user 206A.

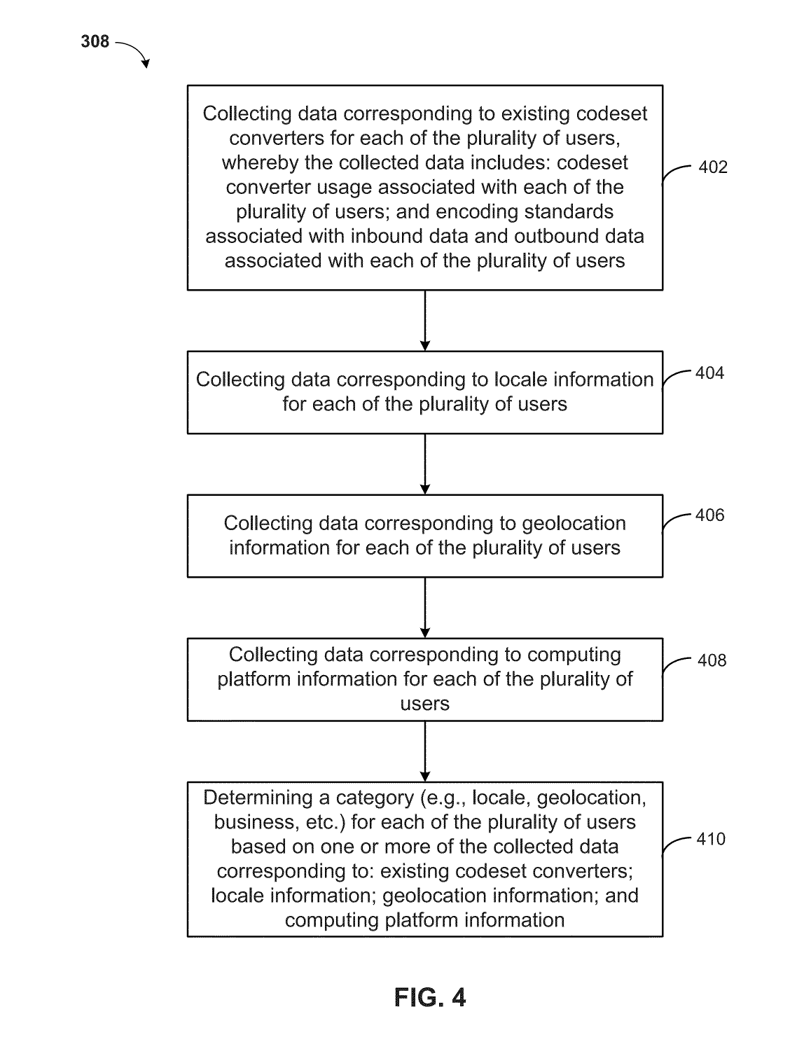

FIG. 4 depicts an exemplary operational flow chart describing the category determining process 308 within the operational flow chart of the CCM program 204 of FIG. 3. FIG. 4 is described with the aid of the exemplary embodiments of FIG. 1A, FIG. 1B, and FIG. 2.

At 402, data corresponding to existing codeset converters for each of the plurality of users is collected. The existing codeset converter data may include, among other things, data corresponding to codeset converter usage associated with each of the plurality of users and data corresponding to encoding standards associated with inbound data and outbound data associated with each of the plurality of users. For example, users 206A and 206B (FIG. 2) may use codeset converter 100A (FIG. 1), while users 206C, 206D and 206E (FIG. 2) may use a different codeset converter with a different encoding standard. CCM program 204 (FIG. 2) may determine the codeset converter usage by, among other things, analyzing metadata from one or more files submitted by the plurality of users 206A-206X (FIG. 2). Alternatively, CCM program 204 may determine the codeset converter usage by polling each of the plurality of users 206A-206X directly using a daemon.

At 404, data corresponding to locale information for each of the plurality of users is collected. It may be appreciated that the process of collecting the locale information data is substantially similar to the process of collecting codeset converter usage data, as discussed above. For example, as, previously described, non-limiting exemplary locale information data may include, among other things, information corresponding to language and culture settings, running codeset converters, and default languages.

At 406, data corresponding to geolocation information for each of the plurality of users is collected. It may be appreciated that the process of collecting the geolocation information data is substantially similar to the process of collecting codeset converter usage data, as discussed above. For example, as, previously described, non-limiting exemplary geolocation information data may include, among other things, information corresponding a user's physical location, country data, and province data.

At 408, data corresponding to computing platform information for each of the plurality of users is collected. It may be appreciated that the process of collecting the computing platform information data is substantially similar to the process of collecting codeset converter usage data, as discussed above. For example, as, previously described, non-limiting exemplary computing platform information data may include, among other things, information corresponding to operating system names, releases, and versions; running and installed codeset converters; running and installed applications; user profiles and related information; application profiles; platforms of connected clients and servers; and major encodings of inbound and outbound data.

At 410, a category for each of the plurality of users is determined from among one or more predetermined categories, based on the collected data (e.g., existing codeset converters, locale, geolocation, computing platform, etc.). For example, CCM program 204 may determine user 206A (FIG. 2) and user 206B (FIG. 2) to belong to a substantially similar category based on similarities in their respective collected data. In some implementations, the similarities may be determined by a correlation factor and a correlation threshold such that once the correlation factor exceeds the correlation threshold, a category matching of the users (e.g., users 206A and 206B) can be made.

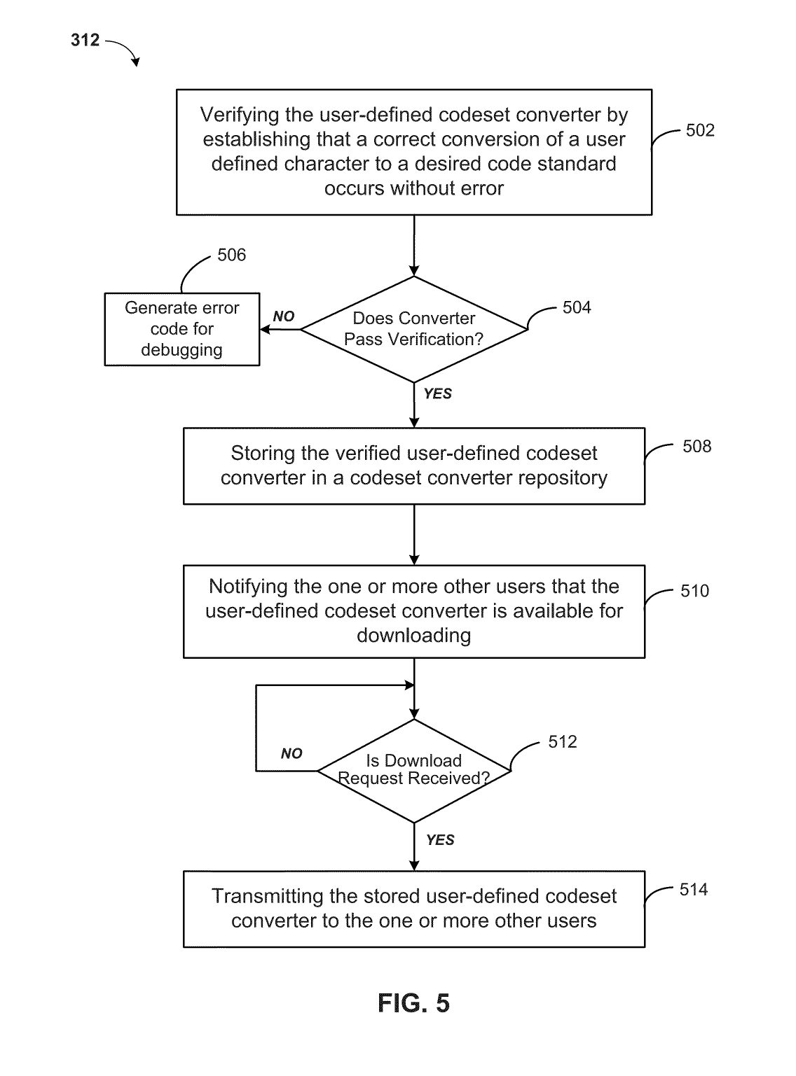

FIG. 5 depicts an exemplary operational flow chart of the distribution process 312 within the operational flow chart of the CCM program 204 of FIG. 3. FIG. 5 is described with the aid of the exemplary embodiments of FIG. 1A, FIG. 1B, and FIG. 2.

At 502, the user defined codeset converter is verified by establishing that a correct conversion of a user-defined character to a desired codeset standard occurs without error. For example, CCM program 204 (FIG. 2) may test user-defined codeset converter 100B (FIG. 1B) to ensure that user-defined character 102 (FIG. 1B) is converted correctly. Particularly, the verification ensures that the user defined character (i.e., [symbol] in Unicode displays the corresponding user define character in GB 18030 based on the customized conversion mapping within the user-defined codeset converter 100B.

At 504, the user-defined codeset converter is checked to see if the user-defined codeset converter passes the verification test. For example, CCM program 204 may check to see if user-defined codeset converter 100B (FIG. 1B) passed verification. If user-defined codeset converter 100B fails to convert user-defined character 102 (FIG. 1B) correctly, user-defined codeset converter 100B may be deemed to have failed verification. Conversely, if user-defined codeset converter 100B correctly displays user-defined character 102, user-defined codeset converter 100B may be deemed to have passed verification.

At 506, an error code for debugging is generated if the user-defined codeset converter does not pass verification. For example, CCM program 204 may notify server 202 (FIG. 2) that user-defined codeset converter 100B (FIG. 1B) created by user 206A (FIG. 2) contains an error. CCM program 204 may notify user 206A, over communications network 208 (FIG. 2), that the user-defined codeset converter 100B contains an error. User 206A may then accordingly correct the error and upload a corrected user-defined codeset converter to server 202 via communications network 208.

At 508, the verified user-defined codeset converter is stored in a central codeset converter repository. For example, upon verifying that user-defined codeset converter 100B (FIG. 1B) is free from errors, CCM program 204 may store user-defined codeset converter 100B on server 202 (FIG. 2). CCM program 204 may also make user-defined codeset converter 100B available for download by one or more other users from among the plurality of users 206A-206X (FIG. 2).

At 510, one or more other users from among the plurality of users are notified that the user-defined codeset converter relevant to them based on criteria determination is available for downloading. For example, CCM program 204 may notify only those users determined to belong to the substantially identical category to user 206A (FIG. 2) via communications network 208 (FIG. 2) that user-defined codeset converter 100B (FIG. 1B) is available for download. Alternatively, CCM program 204 may notify users 206B-206X (FIG. 2) via communications network 208 that user-defined codeset converter 100B created by user 206A is available for download. This option may be utilized when a limited number of users are monitored by the CCM program 204.

At 512, the CCM system checks if a download request has been received. For example, after notifying the one or more other users 206B-206X (FIG. 2) that user-defined codeset converter 100B (FIG. 1B) is available for download, CCM program 204 may wait to receive a download request. If a download request is not received, CCM program 204 may continue to wait.

At 514, if a download request is received, the stored user-defined codeset converter is transmitted to the one or more other users. For example, CCM program 204 may receive a download request from user 206C (FIG. 2). The CCM program 204 may then transmit the user-defined codeset converter received from user 206A (FIG. 2) stored on server 202 (FIG. 2) to user 206C (FIG. 2) over communications network 208 (FIG. 2).

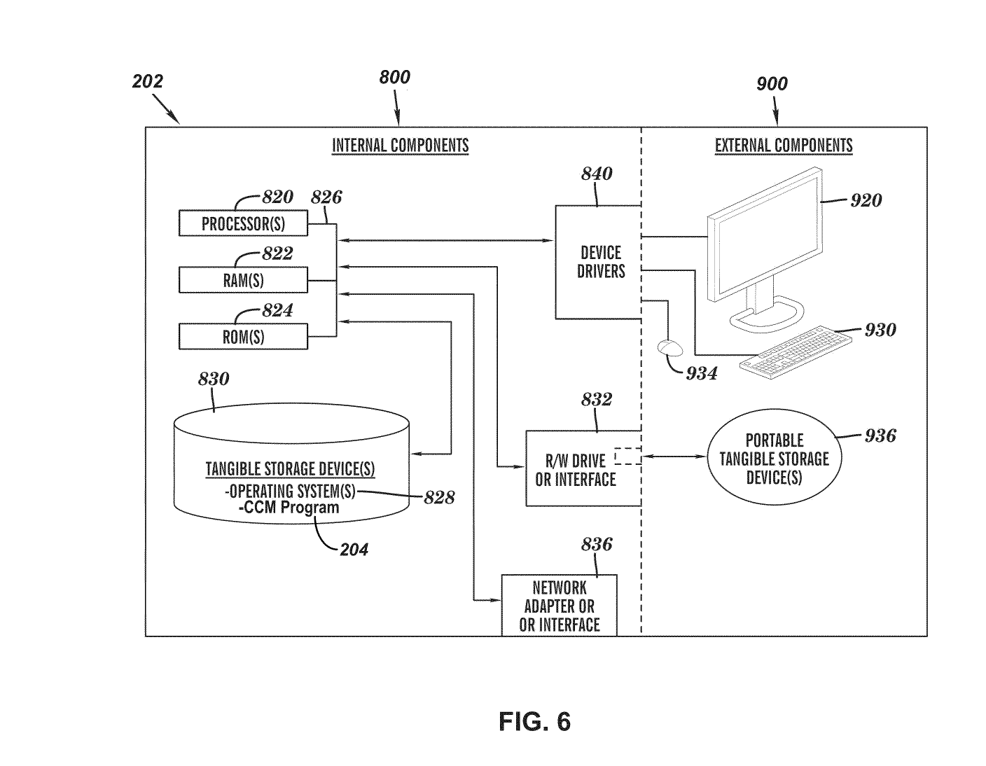

FIG. 6 shows a block diagram of the components of a data processing system 800, 900, that may be incorporated within server 202 (FIG. 1) in accordance with an illustrative embodiment of the present invention. It should be appreciated that FIG. 6 provides only an illustration of one implementation and does not imply any limitations with regard to the environments in which different embodiments may be implemented. Many modifications to the depicted environments may be made based on design and implementation requirements.

Data processing system 800, 900 is representative of any electronic device capable of executing machine-readable program instructions. Data processing system 800, 900 may be representative of a smart phone, a computer system, PDA, or other electronic devices. Examples of computing systems, environments, and/or configurations that may represented by data processing system 800, 900 include, but are not limited to, personal computer systems, server computer systems, thin clients, thick clients, hand-held or laptop devices, multiprocessor systems, microprocessor-based systems, network PCs, minicomputer systems, and distributed cloud computing environments that include any of the above systems or devices.

The data processing system 800, 900 may include may include a set of internal components 800 and a set of external components 900 illustrated in FIG. 6. The set of internal components 800 includes one or more processors 820, one or more computer-readable RAMs 822 and one or more computer-readable ROMs 824 on one or more buses 826, and one or more operating systems 828 and one or more computer-readable tangible storage devices 830. The one or more operating systems 828 and programs such as Codeset Converter Management (CCM) program 204 is stored on one or more computer-readable tangible storage devices 830 for execution by one or more processors 820 via one or more RAMs 822 (which typically include cache memory). In the embodiment illustrated in FIG. 6, each of the computer-readable tangible storage devices 830 is a magnetic disk storage device of an internal hard drive. Alternatively, each of the computer-readable tangible storage devices 830 is a semiconductor storage device such as ROM 824, EPROM, flash memory or any other computer-readable tangible storage device that can store a computer program and digital information.

The set of internal components 800 also includes a R/W drive or interface 832 to read from and write to one or more portable computer-readable tangible storage devices 936 such as a CD-ROM, DVD, memory stick, magnetic tape, magnetic disk, optical disk or semiconductor storage device. The CCM program 204 can be stored on one or more of the respective portable computer-readable tangible storage devices 936, read via the respective R/W drive or interface 832 and loaded into the respective hard drive 830.

The set of internal components 800 may also include network adapters (or switch port cards) or interfaces 836 such as a TCP/IP adapter cards, wireless wi-fi interface cards, or 3G or 4G wireless interface cards or other wired or wireless communication links. CCM program 204 can be downloaded from an external computer (e.g., server) via a network (for example, the Internet, a local area network or other, wide area network) and respective network adapters or interfaces 836. From the network adapters (or switch port adaptors) or interfaces 836, the CCM program 204 is loaded into the respective hard drive 830. The network may comprise copper wires, optical fibers, wireless transmission, routers, firewalls, switches, gateway computers and/or edge servers.

The set of external components 900 can include a computer display monitor 920, a keyboard 930, and a computer mouse 934. External component 900 can also include touch screens, virtual keyboards, touch pads, pointing devices, and other human interface devices. The set of internal components 800 also includes device drivers 840 to interface to computer display monitor 920, keyboard 930 and computer mouse 934. The device drivers 840, R/W drive or interface 832 and network adapter or interface 836 comprise hardware and software (stored in storage device 830 and/or ROM 824).

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the one or more embodiment, the practical application or technical improvement over technologies found in the marketplace, or to enable others of ordinary skill in the art to understand the embodiments disclosed herein.

1.-10. (canceled)

11. A computer program product for managing customized codeset converters between a plurality of users in communication over a network, comprising:
one or more computer-readable storage devices and program instructions stored on at least one of the one or more tangible storage devices, the program instructions executable by a processor, the program instructions comprising:
instructions to receive, over the network, a user-defined codeset converter from a user associated with the plurality of users;
instructions to determine a category for the user, wherein the category is determined from among a plurality of predetermined categories;
instructions to determine one or more other users associated with the plurality of users that include a substantially identical category to that of the determined category of the user; and
instructions to distribute the received user-defined codeset converter to the one or more other users having the substantially identical category via the network,
wherein the distributed user-defined codeset converter provides a customized codeset mapping table for the user and the one or more other users based on the determined category.

12. The computer program product of claim 11, wherein the instructions to determine the category comprises:
instructions to collect data corresponding to existing codeset converters associated with the user;
instructions to collect data corresponding to a locale associated with the user; and
instructions to collect data corresponding to a geolocation associated with the user.

13. The computer program product of claim 12, wherein the instructions to collect the data corresponding to existing codeset converters comprises:
instructions to collect data corresponding to codeset converter usage associated with the user; and
instructions to collect data corresponding to encoding standards associated with inbound data and outbound data associated with the user.

14. The computer program product of claim 13, wherein the determining of the substantially identical category comprises:
instructions to collect data corresponding to existing codeset converters associated with the one or more other users;
instructions to collect data corresponding to a locale associated with the one or more other users; and
instructions to collect data corresponding to a geolocation associated with the one or more other users.

15. The computer program product of claim 14, wherein the collecting of the data corresponding to existing codeset converters comprises:
instructions to collect data corresponding to codeset converter usage associated with the one or more other users; and
instructions to collect data corresponding to encoding standards associated with inbound data and outbound data associated with the one or more other users.

16. The computer program product of claim 15, wherein the plurality of predetermined categories comprises:
a locale category for identifying language usage;
a geolocation category; and
a business category.

17. The computer program product of claim 11, wherein the instructions to receive the user-defined codeset converter from the user comprises:
instructions to detect a change to a standard codeset mapping table based on the standard codeset mapping table being compared to the customized codeset mapping table; and
instructions to save the customized codeset mapping table associated with the received user-defined codeset converter to a centralized repository.

18. A computer system for managing customized codeset converters between a plurality of users in communication over a network, the computer system comprising:
one or more processors, one or more computer-readable memories, one or more computer-readable tangible storage devices, and program instructions stored on at least one of the one or more storage devices for execution by at least one of the one or more processors via at least one of the one or more memories, wherein the computer system is capable of performing a method comprising:
receiving, over the network, a user-defined codeset converter from a user associated with the plurality of users;
determining a category for the user, wherein the category is determined from among a plurality of predetermined categories, for the user;
determining one or more other users associated with the plurality of users that include a substantially identical category to that of the determined category of the user; and
distributing the received user-defined codeset converter to the one or more other users having the substantially identical category via the network,
wherein the distributed user-defined codeset converter provides a customized codeset mapping table for the user and the one or more other users based on the determined category.

19. The computer system of claim 18, further comprising:
monitoring, over the network, a codeset converter change;
detecting the codeset converter change based on a created user-defined codeset converter by the user; and
notifying the one or more other users that the user-defined codeset converter is available for downloading following the codeset converter change.

20. The computer system of claim 18, wherein the receiving of the user-defined codeset converter from the user comprises:
detecting a change to a standard codeset mapping table based on the standard codeset mapping table being compared to the customized codeset mapping table; and
saving the customized codeset mapping table associated with the received user-defined codeset converter to a centralized repository.
